(19) United States
(12) Patent Application Publication
(10) Pub. No.: US 2025/0256383 A1
(43) Pub. Date: Aug. 14, 2025

(54) A PORTABLE FASTENER GUIDING TOOL

(71) Applicant: ZEKAS BYGGTJENESTER, Drammen (NO)

(72) Inventor: Tomas ZEKAS, Plunge distr. (LT)

(21) Appl. No.: 18/857,119

(22) PCT Filed: Apr. 14, 2022
(86) PCT No.: PCT/IB2022/053508

§ 371 Date: Oct. 15, 2024

(51) Int. Cl. B25C 3/00

(52) U.S. Cl. CPC B25C 3/006

(57) ABSTRACT

This disclosure relates to the tools for holding and guiding fasteners, in particular to the portable fastener guiding tool that is designed to maintain a straight line of fasteners and equal distances between them. The portable fastener guiding tool includes a support plate, at least one sliding part mounted on the upper part of the support plate and configured to attach the fastener, a sliding handle mounted on the side part of the support plate, wherein the sliding handle is pressed near the wall's edge and the upper part of the sliding handle is attached to the beam or batten. The support plate further includes at least one sliding bracket configured for mounting fastener tool, such as nail gun or a drywall screw gun.

### FIELD OF THE INVENTION

This disclosure relates to the tools for holding and guiding fasteners, in particular to the portable fastener guiding tool.

### BACKGROUND ART

The attachment of fasteners like nails, screws, bolts, rivets and other similar fasteners, to the surface like walls, facades and similar surfaces is crucial in construction industry. The fasteners must be guided to the wall in a straight line, thus there is a need of fastener guiding tools, that are able to ensure the attachment of the fasteners in such a way. The tool should be safe to use, must have a simple and cost effective construction.

Patent document CA3069826A1 (published in 2021 Jul. 27) discloses a hand protector against accidents from stray nails when framing. The hand protector includes a base, a first sidewall extending in a downward direction away from a first side of the base, and a first nail stop wall extending laterally away from the first side of the base. The first nail stop is perpendicular the first sidewall. A second sidewall extends in the downward direction away from the second side of the base, and a second nail stop wall extends laterally away from the second side of the base. The second nail stop is substantially parallel to the first nail stop wall and perpendicular to the second sidewall, and the second nail stop wall extends away from the second side of the base such that the second nail stop and the first nail stop are both in a same plane. The nail stop walls may fold upwards for storage.

Patent document CN110900525A (published in 2020 Mar. 24) discloses a wall nail positioning device. The wall nail positioning device comprises a straight rail rod. Two sliding parts are arranged on the rail rod in a sliding fit manner. Sleeveholes arranged by avoiding the rail rod are formed in the sliding parts. The axial direction of the sleeve holes is perpendicular to the wall face. Positioning pins capable of sliding front and back in the axial direction of the sleeve holes are arranged in the sleeve holes in a penetrating manner. The head portions of the positioning pins are arranged by facing the wall face. The connecting line of the axes of the two positioning pins is parallel to the rail rod, and a level bubble parallel to the axial direction of the rail rod is arranged on the rail rod. The tail portions of the positioning pins can be clamped in hole sites of most of suspension parts, the sliding parts fixing the positioning pins can slide at will along the rail rod, during use, the distance between the positioning pins needs to be adjusted firstly so that the positioning pins can be clamped to the hole sites of the to-be-suspended objects, the distance between wall nails can be obtained, and then the distance between the two sliding parts is kept unchanged. The wall nail positioning device is overall moved to the wall face, the tail portions of the positioning pins are pressed or slightly knocked, then traces can be left on the wall face, and then the wall nails are fixed according to the traces.

Patent document US2009193938A1 (published in 2009 Aug. 6) discloses a fastener guiding tool includes a head containing a plurality of indentations of different dimensions for receiving fasteners. Optionally, a magnetic inset element is disposed within each of the indentations. The head may additionally include a level and measure marks. The fastener guiding tool may be made of a compliant plastic material and may be substantially Z shaped. The disclosed faster guiding tool can be used by either a right or left handed person. And it can be used in hard to reach corners either in a vertical, horizontal or oblique position.

In the present invention, the portable fastener guiding tool that is designed to maintain a straight line of fasteners and equal distances between them. The portable fastener guiding tool comprises a support plate, at least one sliding part mounted on the upper part of the support plate and configured to attach the fastener, a sliding handle mounted on the side part of the support plate and configured to set the tool in such a way, that the upper part of the sliding handle is pulled out into the surface. The support plate further comprises at least one sliding bracket configured for mounting fastener tool, such as nail gun or drywall screw gun.

### SUMMARY OF THE INVENTION

The present invention discloses a portable fastener guiding tool that is designed to maintain a straight line of fasteners and equal distances from the edges of the facade to be installed, terrace trim (boards, siding, etc.). The portable fastener guiding tool comprises: a support plate, at least one sliding part mounted on the upper part of the support plate and configured to attach the fastener, a sliding handle mounted on the side part of the support plate, wherein the sliding handle is pressed near the wall's edge and the upper part of the sliding handle is attached to the beam or batten.

The support plate comprises an upper groove arranged longitudinally in the upper part of the support plate from both sides of the supported plate, a top surface arranged longitudinally on the upper surface of the support plate, a side groove arranged on both sides of the support plate perpendicular to the upper groove and the surface, at least one fixing hole arranged on the side surface of the plate.

The sliding part mounted in the upper groove of the support plate comprises an upper recess arranged in the upper portion of the sliding part over its entire width, wherein the direction of the upper recess is perpendicular to the direction of the upper groove, an inner hole extending along the longitudinal direction through all the length of the sliding part, mounted on the groove of the support plate in such a way, that sliding part moves longitudinally in the direction of the upper groove and the top surface, a fixing hole arranged on the upper recess. The upper recess further comprises an additional groove arranged along the upper recess and is used for inserting a fastener.

The sliding handle, mounted in the side groove of the support plate, comprises a groove arranged in the central part of the sliding handle over the entire height of the handle. The groove further comprises an inner elongated groove arranged through all the thickness of the sliding handle.

The support plate further comprises a hole arranged along the upper surface of the support plate, wherein the hole has upper and lower longitudinal grooves with at least one sliding bracket configured to mount the fastener tool. The said sliding bracket comprises at least upper and lower recesses through which the bracket slides within the grooves in the longitudinal direction and a central hole configured for mounting a fastener tool.

The presented portable fastener guiding tool is safe to use, has a simple and cost effective construction.

### BRIEF DESCRIPTION OF THE DRAWINGS

FIG. 1. depicts an isometric view of the portable fastener guiding tool.

FIG. 2. depicts an isometric view of the support plate of the portable fastener guiding tool.

FIG. 3. depicts an isometric view of the sliding part of the portable fastener guiding tool.

FIG. 4. depicts an isometric view of the sliding handle of the portable fastener guiding tool.

FIG. 5. depicts an isometric view of the portable fastener guiding tool with a sliding bracket.

FIG. 6. depicts an isometric view of the sliding bracket of the portable fastener guiding tool.

### DETAILED DESCRIPTION OF THE INVENTION

The following detailed description describes a portable fastener guiding tool that is designed to maintain a straight line of fasteners and equal distances from the edges of the facade to be installed, terrace trim (boards, siding, etc.). The term “fastener” includes, but not limits to, nails, screws, bolts, rivets and other similar fasteners. In particular, the present invention discloses the portable fastener guiding tool (100) comprising at least a support plate (101), at least one sliding part (102) and a sliding handle (103).

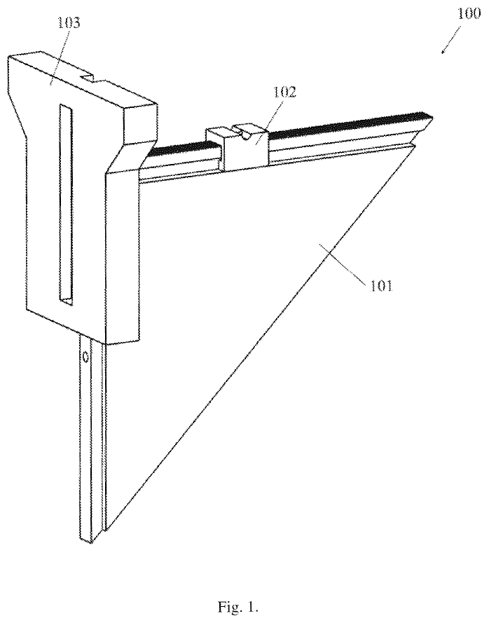

While the tool (100) is illustrated in the form factor as it showed in FIG. 1, other implementations of the tool (100) are not limited to the illustrated form, locations/orientation of various components, and the like.

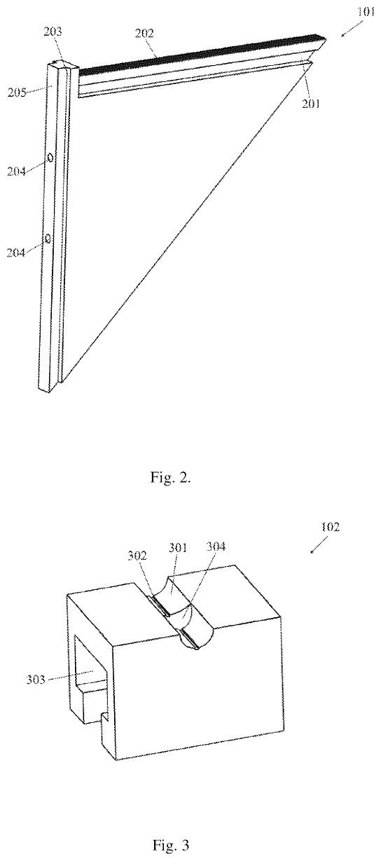

The support plate (101) illustrated in FIG. 2 comprises an upper groove (201) arranged longitudinally in the upper part of the support plate (101) from both sides of the supported plate (102), a top surface (202) arranged longitudinally on the upper surface of the support plate (101), a side groove (203) arranged on both sides of the support plate (102) perpendicular to the upper groove (201) and the top surface (202), at least one fixing hole (204) arranged on the side surface 205) of the plate (101). The upper groove (201) is configured for moving of at least one sliding part (102) in the longitudinal direction along the upper part of the support plate (101). The top surface (202) is configured to lock the position of at least one sliding part (102) in the longitudinal direction with respect to the upper part in order to be able to lock the sliding part (102) at a certain distance. The side groove (203) is configured for moving of the sliding handle (203) in a longitudinal direction perpendicular to the direction of movement of the sliding part (102). At least one fixing hole (204) is configured to fix the position of sliding handle (103) with a fastener like screw or bolt. The support plate (101) preferably is in the shape of a straight triangle. The support plate (101) can be made of metal, plastic or other materials with similar mechanical properties.

The sliding part (102) illustrated in FIG. 3 mounted in the upper groove (201) of the support plate (101) comprises an upper recess (301) arranged in the upper portion of the sliding part (102) over its entire width, wherein the direction of the upper recess (301) is perpendicular to the direction of the upper groove (201), an inner hole (303) extending along the longitudinal direction through all the length of the sliding part (102), mounted on the groove (201) of the support plate (101) in such a way, that sliding part (102) moves longitudinally in the direction of the upper groove (201) and the top surface (202), a fixing hole (304) arranged on the upper recess (301). The upper recess (301) of the sliding part (102) is configured for inserting a fastener and attaching it in a straight line to the fastening surface. The upper recess (301) further comprises an additional groove (302) arranged along the upper recess (301) and is used for inserting a fastener, such as a nail. The fixing hole (304) is configured to fix the sliding part (102) in a stationary position with a fastener like screw or bolt. The sliding part (102) is preferably in the shape of a rectangular parallelepiped. The sliding part (102) can be made of metal, plastic or other materials with similar mechanical properties.

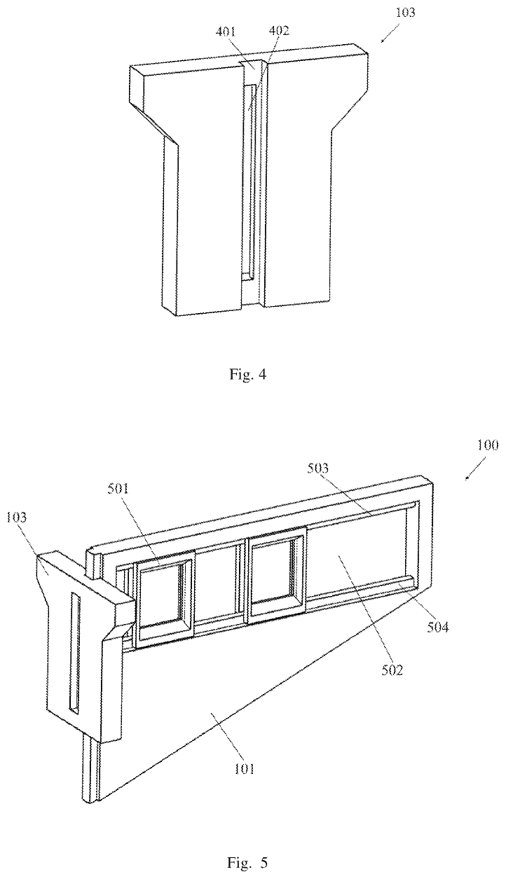

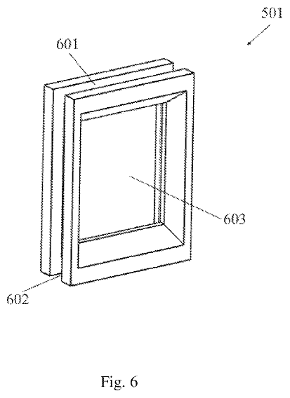

The sliding handle (103) illustrated in FIG. 4, mounted in the side groove (203) of the support plate (101), comprises a groove (401) arranged in the central part of the sliding handle (103) over the entire height of the handle (103). The groove (401) further comprises an inner elongated groove (402) arranged through all the thickness of the sliding handle (103) and is configured to put through the fastener, like screw or bolt, to at least one fixing hole (204) to fix the stationary position of the sliding handle (103). The sliding handle (103) is fixed by the thickness of the beam. The upper part of the sliding handle (103) is attached to the beam or batten, in such a way that it is able turning the bolts or nails fastened to the center of the beam or batten, and is able to maintain a parallel line with the beam or batten. The side part of the sliding handle (103) is pressed against the edge of the finishing part to be installed (boards, siding, etc.), maintaining an angle of 90 degrees with respect to the board and fasteners. The sliding handle (103) has preferably a T-shape. The sliding handle may be made of metal, plastic or other materials with similar mechanical properties.

In another embodiment, the portable fastener guiding tool (100) illustrated in FIG. 5 is adopted to mount the fastener tool, such as a nail gun or dry wall screw gun. The support plate (101) further comprises a hole (502) arranged along the upper surface of the support plate (101), wherein the hole (502) has upper and lower longitudinal grooves (502, 503) with at least one sliding bracket (501) configured to mount the fastener tool, like for example, a nail gun or dry wall screw gun. The said sliding bracket (501) comprises at least upper and lower recesses (601, 602) through which the bracket (501) slides within the grooves (502, 503) in the longitudinal direction and a central hole (603) configured for mounting a fastener tool, for example a nail gun, or drywall screw gun.

The use of the portable fastener guiding tool (100) for maintaining a straight line of fasteners and equal distances between them comprising the following steps:
the tool (100) is attached near the wall's edge by fixing the required position of sliding handle (103);
the required position of at least one sliding part (102) is fixed;
the fastener is placed on the sliding part (102) in the upper recess (301);
the fastener is attached to the wall at initial position and after removing the tool (100) from the wall's edge, the fastener is fully attached to the wall.

The terms “attached,” “connected,” and the like are used herein to mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is to be understood that although the present invention has been described with regard to embodiments thereof, various other embodiments and variants may occur to those skilled in the art, which are within the scope of the invention. Those skilled in the art will readily appreciate that many modifications are possible (e.g., variations in sizes, structures, shapes and proportions of the various elements, mounting arrangements, use of materials, orientations, etc.) without materially departing from the novel teachings and advantages of the subject matter described herein. For example, the order or sequence of any process or method steps may be varied or re-sequenced according to alternative embodiments. Other substitutions, modifications, changes, and omissions may also be made in the design, operating conditions and arrangement of the various exemplary embodiments without departing from the scope of the present disclosure.

With respect to the use of substantially any plural and/or singular terms herein, those having skill in the art can translate from the plural to the singular and/or from the singular to the plural as is appropriate to the context or application. The various singular/plural permutations may be expressly set forth herein for clarity.

1. A portable fastener guiding tool used to maintain a straight line of fasteners and equal distances between them, wherein the tool comprises:
a support plate,
at least one sliding part mounted on the upper part of the support plate and configured to attach the fastener,
a sliding handle, mounted on the side part of the support plate, wherein the sliding handle is pressed near the wall's edge and the upper part of the sliding handle is attached to the beam or batten.

2. The portable fastener guiding tool according to claim 1, wherein the support plate comprises an upper groove arranged longitudinally in the upper part of the support plate from both sides of the supported plate, a top surface arranged longitudinally on the upper surface of the support plate, a side groove arranged on both sides of the support plate perpendicular to the upper groove and a top surface, at least one fixing hole arranged on the side surface of the plate.

3. The portable fastener guiding tool according to claim 1, wherein the sliding part mounted in the upper groove of the support plate comprises an upper recess arranged in the upper portion of the sliding part over its entire width, wherein the direction of the upper recess is perpendicular to the direction of the upper groove, an inner hole extending along the longitudinal direction through all the length of the sliding part, mounted on the groove of the support plate in such a way, that sliding part moves longitudinally in the direction of the upper groove and the top surface, a fixing hole arranged on the upper recess.

4. The portable fastener guiding tool according to claim 3, wherein the upper recess further comprises an additional groove arranged along the upper recess and is used for inserting a fastener.

5. The portable fastener guiding tool according to claim 1, wherein the sliding handle, mounted in the side groove of the support plate, comprises a groove arranged in the central part of the sliding handle over the entire height of the handle.

6. The portable fastener guiding tool according to claim 5, wherein the groove further comprises an inner elongated groove arranged through all the thickness of the sliding handle.

7. The portable fastener guiding tool according to claim 1, wherein the support plate further comprises a hole arranged along the upper surface of the support plate, wherein the hole has upper and lower longitudinal grooves with at least one sliding bracket configured to mount the fastener tool.

8. The portable fastener guiding tool according to claim 7, wherein the said sliding bracket comprises at least upper and lower recesses through which the bracket slides within the grooves in the longitudinal direction and a central hole configured for mounting a fastener tool.

9. A method of using the portable fastener guiding tool according to claim 1 for maintaining a straight line of fasteners and equal distances between them, comprising the following steps:
the tool is attached near the wall's edge by fixing the required position of sliding handle;
the required position of at least one sliding part is fixed;
the fastener is placed on the sliding part in the upper recess;
the fastener is attached to the wall at initial position and after removing the tool from the wall's edge, the fastener is fully attached to the wall.
